(19) United States
(12) Patent Application Publication
(10) Pub. No.: US 2005/0281651 A1
(43) Pub. Date: Dec. 22, 2005

(54) Hook lift hoist adaptable for use with containers of variabile length

(76) Inventors: David Simpson, Windsor Heights, IA (US); Thomas Waldschmitt, Ankeny, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/840,124

(22) Filed: May 6, 2004

(51) Int. Cl. B62B 1/00

(52) U.S. Cl. 414/491

(57) ABSTRACT

A container variability system for use with a hook-lift hoist mounted onto a wheeled chassis and including at least one hydraulic cylinder for loading a container onto the chassis and for tilting said container to a raised off-loading position. The hydraulic cylinder is responsible for the horizontal movement of the container on the main frame of the hoist through a telescopic jib member. A tab mounted off of the longsill of the container actuates a switch that prevents further extension of the cylinder.

### BACKGROUND OF THE INVENTION

The present invention relates to an improved hook-lift hoist that allows containers of variable length and, more specifically, containers that are shorter than the minimum specified length to be transported on a truck equipped with a single hook-lift hoist.

The hoist has a pivotable L-shaped arm with a hook on its distal end portion that is used to engage a detachable truck box or container. The arm is pivoted to lift the container onto a wheeled chassis for transport of the container and its contents to any location. It has also become known that the hook-lift hoist is operable to tilt a loaded container to dump its contents rearwardly of the truck. Hook-lift hoists allow for a single truck chassis to be used with a wide variety of truck boxes, each of which has a distinct and advantageous use. A single truck chassis with a hook-lift hoist can be used, for example, to load, transport, and dump open-topped waste receptacles to a disposal site; to load, transport, and unload shipping containers; to mount, use, and dismount road maintenance equipment, such as a salt spreader; to load, transport, and unload wheeled equipment; and so on. This functional versatility makes hook-lift hoists an economical vehicle for transport industries, particularly the street and highway maintenance departments of municipalities, states, and other governmental entities where budgetary constraints and the variety of tasks that must be performed make these multi-purpose vehicles an attractive choice.

The versatility of a conventional hook-lift hoist is restricted, however, by the minimum container length requirement. Typically, the minimum container length is determined by the shortest container that can be stowed at the forward most position on the hoist, while leaving an adequate amount of the container rearward of the hoist to ensure that the payload or contents of the container do not contact the back of the hoist or truck chassis when the container is raised into a dump position. Therefore, the conventional hook-lift hoist is usually delivered to operators with a minimum specified length requirement for containers to be transported. This minimum length requirement limits the overall range of container lengths and diminishes the usefulness and capabilities of the hook-lift hoist. The invention herein seeks to address this limitation by taking advantage of a telescopic jib boom design in a hook-lift hoist to accommodate containers shorter than the specified minimum length, thereby increasing the versatility of the hook-lift hoist.

The use of containers of shorter than specified minimum length requires the operator to position the containers properly on the hook-lift hoist so that adequate container overhang behind the hoist is reserved for dumping of the payload. Improper loading of the container could result in damage of the back of the hoist or the truck chassis. Thus a mechanism is needed for proper container placement on the hoist. The present invention relates to such a mechanism incorporated into the hoist design to cause the container to stop at controlled positions.

### SUMMARY OF THE INVENTION

The invention herein contemplates the use of a Container Variability System (CVS) consisting of a telescopic jib boom and a container position control mechanism on a hook-lift hoist to maximize the capabilities of hoists in handling containers of variable length. The telescopic jib boom moves a container forward and rearward laterally on the hoist by the extension or retraction of a hydraulic jib cylinder, respectively. CVS facilitates a hook-lift hoist operator to load containers shorter than the minimum specified length by automatically restricting the maximum forward placement of the container on the hoist. Allowance is made for enough forward placement of the container to engage hoist body locks, yet remain sufficiently rearward of the back of the hoist.

Controlled placement of the container on the hoist is achieved in the preferred embodiment by providing for a bypass in the hydraulic oil required for extension of the hydraulic jib cylinder thereby causing the container to stop at a controlled location. A mechanically operated hydraulic valve is situated next to a lever with an eccentric cam. The lever rotates counter clockwise when it is struck by a tab of a forward moving container. A spool on the mechanical valve is then depressed by the eccentric cam, which actuates the valve. The actuated valve allows the hydraulic oil to flow back into a hydraulic tank and bypass the jib cylinder extension circuit, thereby preventing further extension of the hydraulic jib cylinder. These events cause the container to stop at the specific location along the hook-lift hoist. Similarly, a lever actuated limit switch can be used for a manually operated system. The switch, when struck, would signal an electric solenoid operated hydraulic valve to activate and dump the hydraulic oil back into the hydraulic tank.

In an alternative embodiment, a lever actuated limit switch, when struck, could interrupt the circuit to the appropriate solenoid on the hydraulic control valve in an electric controlled hoist. In a hoist with pneumatic operated controls, a lever actuated pneumatic valve, when struck, could open and bleed off air supplied to the appropriate pneumatic shift kit on the jib extension circuit of the control valve. The controlled placement of containers, particularly those shorter than the minimum specified length, protects the rear end of the hoist or the truck chassis during dumping of the payload. CVS therefore increases the overall range of container lengths a hoist can carry and dump effectively.

Accordingly, an object of the invention is to provide a telescopic jib boom that moves a container laterally along the hoist and is controllable by using a lever actuated switch.

Another object of the invention is to provide a position control mechanism to place the container at a specified location on the hoist.

A further object of the invention is to enable a hook-lift hoist to accommodate containers shorter than specified minimum length in a single truck chassis for effective transportation and dumping of the payload.

These and other objects of the invention will be understood by a person skilled in the art upon a review of the specification, the associated drawings, and the appended claims.

### BRIEF DESCRIPTION DRAWINGS

FIG. 1 is a side view of a hook-lift hoist truck with a container variability system of the present invention.

FIG. 2 is an enlarged, detailed side view of a position control system of the CVS showing a lever with eccentric cam in contact with a tab mounted off of container longsill.

### DETAILED DESCRIPTION OF THE PREFERRED EMBODIMENT

U.S. Pat. No. 5,601,393 which shows constructional features of a hook-lift hoist is herein incorporated by reference.

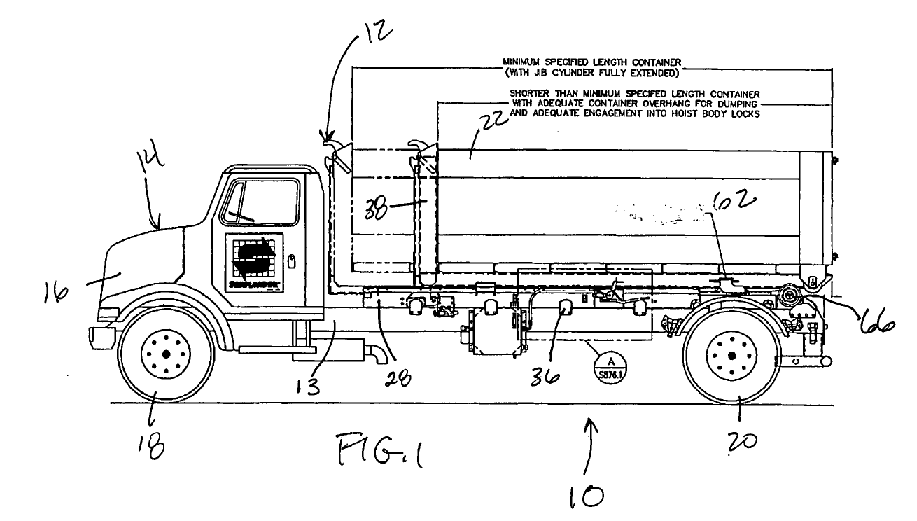

Illustrated in FIG. 1, generally at 10, is a container variability system of the present invention that is incorporated into a hook-lift hoist 12 mounted on a truck 14 having a chassis 13 and cab 16 supported on front wheels 18 and rear wheels 20. The container variability system 10 allows carrying and dumping of shorter than minimum specified length containers 22 on the same hook-lift hoist 12 equipped truck chassis 13 used for containers that meet the minimum specified length requirement.

Detailed showings of the hook-lift hoist 12 are illustrated in U.S. Pat. No. 5,601,393. The hoist 12 is made by Swaploader U.S.A., Ltd., Des Moines, Iowa and is sold under the trademark SWAPLOADER. Briefly, the hook-lift hoist 12 includes a mainframe 28 that is mounted to the chassis 13 by a plurality of mounting plates 36. An articulated hook-lift arm 38 is mounted to the mainframe 28 for pivotal movement about a horizontal axis. The hook-lift arm 38 is pivoted by a pair of hydraulic cylinders that are supplied with pressurized hydraulic oil by a hydraulic fluid supply system. This pair of cylinders are primarily responsible for the lifting and loading of the container 22 onto the hoist. Continued horizontal, forward movement of the container 22 is achieved by the telescopic movement of a jib member through the extension of a jib hydraulic cylinder. Extension and retraction of this jib cylinder is also dependent on the supply of hydraulic oil by a hydraulic pump and valve station.

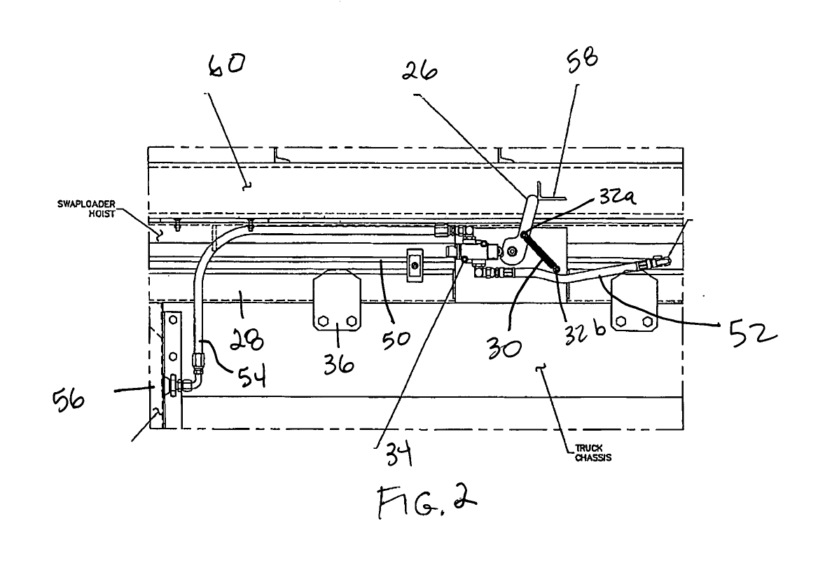

The container variability system 10 includes a lever with an eccentric cam 26 that is mounted onto the side of the mainframe 28 of hoist 12 (FIG. 2). The upwardly extending arm of lever 26 is held in place by an angled spring 30. One end of the spring 30 is affixed to the lower portion of the lever arm 26 by pin 32a, and the other end of the spring 30 is suitably mounted onto the lower right hand side of the mainframe 28 by pin 32b. The extension of spring 30 allows counterclockwise pivotal movement of the lever 26. A mechanical hydraulic valve 34 is situated in close proximity to the lever 26. The spool of the mechanical hydraulic valve 34 is nested in a recess of the eccentric cam of lever 26 when spring 30 is in a relaxed state. The mechanical valve 34 interconnects with the pressurized hydraulic oil supply lines 50, a line 52 leading to the jib extension circuit, and a line 54 leading to a hydraulic oil tank 56. An L-shaped tab 58 is installed on the proper position of the longsill 60 of container 22. When the tab 58 hits the lever 26, the angled spring 30 extends and the lever 26 pivots counter clockwise. Consequently, the spool of the mechanical valve 34 rotates out of the groove of the eccentric cam of lever 26 and is compressed by the eccentric cam of lever 26. The compressed spool of the mechanical valve 34 actuates the valve 34, which allows pressurized hydraulic oil to dump into the hydraulic oil tank 56 and bypass the jib cylinder extension circuit. Continued extension of the jib cylinder 42 is thus halted due to lack of hydraulic oil supply. The forward movement of container 22 on the hoist 12 is in turn stopped at the point of contact between the tab 58 and lever 26.

The position of the tab 58 on the side of the container longsill determines the extent of the forward movement of container 22. This tab 58 can be made of metal or other hard, resistant material such as polypropylene and is found on the side where the CVS is located. It is to be installed along a line that crosses the upper portion of the arm of lever 26 so that it could hit the lever when the forwardly moving container 22 reaches the intended stop point on the hoist 12. For safe transport of the container 22 and later effective dumping of payload, the location of the tab 58 has to be such that enough allowance is made for forward placement of the container 22 to engage hoist body locks 62 (FIG. 1), and yet there still remains sufficient container overhang past the rear of hoist 12. The precise location of the tab 58 has to be determined based on each container's length. For container 22 that is equal to or longer than the minimum specified length, the tab 58 is positioned to allow the jib cylinder 42 to fully extend for maximum engagement of container 22 in hoist 12 through the hoist body locks 62. For shorter than minimum specified length container 22, care needs to be taken to position the tab 58 to accommodate enough container engagement in the hoist and sufficient container overhang past the rear of the hoist.

A shorter than minimum specified length container 22 is raised and brought into contact with a pair of flanged rollers 66 which serve to decrease the force required to drag the container 22 onto the truck 14 and to keep it centered relative to the truck 14 (FIG. 1). The above maneuver is accomplished through the retraction of the pair of hydraulic cylinders. Full retraction of the cylinders brings the container 22 into a transport position where the container 22 is supported on the mainframe 28. Once the container 22 is placed horizontally on the hoist, it is slid forwardly through the telescopic movement of jib member, which is driven by the extension of jib cylinder. When the tab 58 (FIG. 2) mounted off of the longsill of container 22 hits the lever 26, the continued forward movement of the container is halted because the hydraulic oil bypasses the jib cylinder extension circuit, which prevents further extension of the jib cylinder and the telescopic movement of jib member. The container 22 is then secured onto the mainframe 28 by hoist body locks 62 for storage and transport. Because of the proper placement of short container 22 on the hoist 12, dumping of payload from the container 22 does not damage the back portion of the hoist 12.

Although the invention has been described with respect to a preferred embodiment thereof, it is to be also understood that it is not to be so limited since changes and modifications can be made therein which are within the full intended scope of this invention as defined by the appended claims.

1. A container variability system for use with a hook-lift hoist mounted onto a wheeled chassis having four wheels and including at least one hydraulic cylinder for loading a container onto said chassis and for tilting said container to a raised off-loading position, wherein said hydraulic cylinder is responsible for the horizontal movement of said container on the main frame of said hoist through a telescopic jib member, wherein said system comprises a lever actuated switch for preventing further extension of said cylinder, wherein said switch is activated by a strike from a tab mounted off of the longsill of said container.

2. A container variability system as defined in claim 1, wherein said system is mounted on either side of said main frame of said hoist, and wherein said tab is mounted on the same side of the longsill of said container as said system.

3. A container variability system as defined in claim 1, wherein said tab is made of metal or other hard, resistant material.

4. A container variability system as defined in claim 1, wherein said tab is mounted off of the longsill of said container in a suitable position to strike said lever switch when said container slides forwardly to said lever switch, and said tab is positioned such that adequate length of said container is engaged in said hoist through hoist body locks for safe transport and that enough overhang of said container past rear of said hoist is preserved for effective dumping.

5. The hoist body locks of claim 4, wherein said body locks are positioned close to the rear end of said hoist on either side of said main frame as a safety measure.

6. A container variability system as defined in claim 1, wherein said system allows said containers shorter than a minimum specified length to be transported and its payload dumped effectively without damaging the rear of said hoist.

7. A container variability system as defined in claim 1, wherein said system allows said containers longer than or equal to said minimum specified length to be transported and its payload dumped effectively without damaging the rear of said hoist.

8. A container variability system according to claim 1, wherein said hydraulic cylinder drives a telescopic jib member to slid forward said container on said hoist, wherein the extension of said hydraulic cylinder is dependent on pressurized hydraulic oil, wherein the depletion of said hydraulic oil halts the extension of said cylinder, wherein the supply of said hydraulic oil is controlled by said lever actuated switch comprising a mechanical hydraulic valve and a lever with an eccentric cam.

9. A container variability system according to claim 8, wherein said mechanical valve is actuated when a spool on said valve is depressed by said eccentric cam when said lever moves counter clockwise by the strike from said tab mounted on the longsill of said container, wherein the actuated valve allows said hydraulic oil to flow into a hydraulic tank and bypass said extension circuit of said cylinder.

10. A container variability system according to claim 8, wherein said lever is held upright by an extension spring which allows said counter clockwise movement of said lever.
